(19) United States
(12) Patent Application Publication
(10) Pub. No.: US 2025/0180872 A1
(43) Pub. Date: Jun. 5, 2025

(54) OPTICAL SYSTEM AND IMAGE PICKUP APPARATUS HAVING THE SAME

(71) Applicant: CANON KABUSHIKI KAISHA, Tokyo (JP)

(72) Inventor: Masatsugu NAKANO, Tochigi (JP)

(21) Appl. No.: 18/922,490

(22) Filed: Oct. 22, 2024

(30) Foreign Application Priority Data
Dec. 4, 2023 (JP) 2023-204465

(51) Int. Cl. G02B 13/00; G02B 9/10

(52) U.S. Cl. CPC G02B 13/0045; G02B 9/10

(57) ABSTRACT

An optical system includes, in order from an object side to an image side, a front group that includes, in order from the object side to the image side, a first lens having negative refractive power and a second lens having an aspheric surface, and a rear group includes, in order from the object side to the image side, a third lens having positive refractive power, a fourth lens having positive refractive power, a fifth lens having negative refractive power, and a sixth lens having an aspheric surface. On an optical axis, an object-side surface of the first lens is convex, an object-side surface of the second lens is convex, and an object-side surface of the sixth lens is concave.

### BACKGROUND

### Technical Field

The present disclosure relates to an optical system suitable for image pickup apparatuses such as digital still cameras, digital video cameras, on-board (in-vehicle) cameras, mobile phone cameras, surveillance cameras, wearable cameras, and medical cameras.

### Description of Related Art

Optical systems for image pickup apparatuses such as on-board cameras are demanded to have a wide angle of view. Japanese Patent Laid-Open No. 2010-9028 discloses a wide-angle lens with a projection characteristic close to that of an orthogonal projection method.

However, the wide-angle lens disclosed in Japanese Patent Laid-Open No. 2010-9028 does not meet the miniaturization demand.

### SUMMARY

An optical system according to one aspect of the disclosure includes, in order from an object side to an image side, a front group, and a rear group. The front group includes, in order from the object side to the image side, a first lens having negative refractive power and a second lens having an aspheric surface. The rear group includes, in order from the object side to the image side, a third lens having positive refractive power, a fourth lens having positive refractive power, a fifth lens having negative refractive power, and a sixth lens having an aspheric surface. On an optical axis, an object-side surface of the first lens is convex, an object-side surface of the second lens is convex, and an object-side surface of the sixth lens is concave. An image pickup apparatus and an imaging system each having the above optical system also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a schematic diagram of the main parts of an optical system according to Example 1.

FIG. 2 is an aberration diagram of the optical system according to Example 1.

FIG. 3 is a schematic diagram of the main parts of an optical system according to Example 2.

FIG. 4 is an aberration diagram of the optical system according to Example 2.

FIG. 5 is a schematic diagram of the main parts of an optical system according to Example 3.

FIG. 6 is an aberration diagram of the optical system according to Example 3.

FIG. 7 is a schematic diagram of main parts of an optical system according to Example 4.

FIG. 8 is an aberration diagram of the optical system according to Example 4.

FIG. 9 is a schematic diagram of the main parts of the optical system according to Example 5.

FIG. 10 is an aberration diagram of the optical system according to Example 5.

FIGS. 11A to 11E illustrate an aspheric shape of an object-side surface of a second lens according to each Example.

FIGS. 12A to 12E illustrate a tilt of an object-side surface of a sixth lens according to each Example.

FIGS. 13A to 13E illustrate a tilt of an image-side surface of the sixth lens according to each Example.

FIG. 14 is a schematic diagram of an image pickup apparatus according to this embodiment.

FIGS. 15A and 15B are schematic diagrams of a movable apparatus according to this embodiment and illustrate an optical characteristic of an optical system.

FIG. 16 is a block diagram illustrating an example configuration of an on-board system according to this embodiment.

### DETAILED DESCRIPTION

Referring now to the accompanying drawings, a detailed description will be given of embodiments according to the disclosure. Each drawing may be drawn at a scale different from the actual scale for convenience. Corresponding elements in respective figures will be designated by the same reference numerals, and a duplicate description thereof will be omitted.

Optical systems for image pickup apparatuses such as on-board cameras are demanded to have a wide angle of view, and fisheye lenses are mainly used. Known projection methods for fisheye lenses include an orthogonal projection method, an equidistant projection method, and a stereoscopic projection method. Each projection method is expressed by the following expression:

Orthogonal projection method: Y=f×sin θ

Equidistant projection method: Y=f×θ

Stereoscopic projection method: Y=2×f tan(θ/2)

where Y is an image height on a projection plane, f is a focal length of the entire optical system, and θ is a half angle of view.

The orthogonal projection method has a characteristic of more strongly compressing an image at a periphery of a screen relative to an image near an optical axis. The equidistant projection method has a constant resolution regardless of an angle of view. The stereoscopic projection method has a characteristic of more strongly compressing an image around the optical axis than an image at the periphery of the screen, which is opposite to the orthogonal projection method.

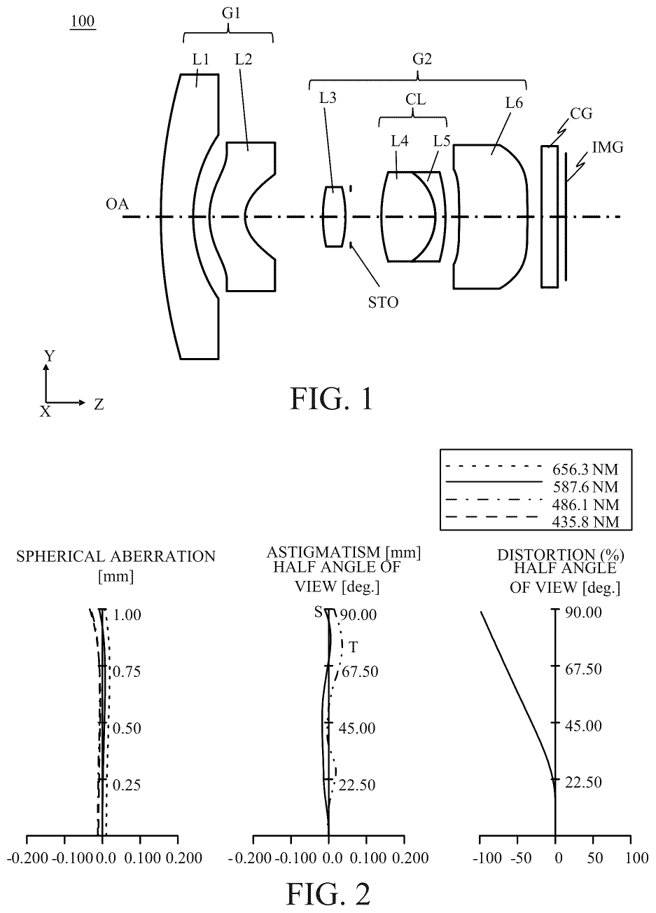

FIGS. 1, 3, 5, 7, and 9 are sectional views having an optical axis OA of the optical systems according to Examples 1 to 5, respectively. In each sectional view, a left side is an object side (front side) and a right side is an image side (rear side). The optical system according to each example is an imaging optical system for an image pickup apparatus, and an imaging surface of an image sensor is placed at the position of an image plane IMG. A cover glass (optical block) CG placed on the object side of the image plane IMG is an optical element such as an optical filter or cover glass that does not contribute to imaging of the optical system. The optical system according to each example may be used as a projection optical system in a projection apparatus such as a projector. In that case, a display surface of a display element such as a liquid crystal panel is disposed at a position of the image plane IMG.

FIGS. 2, 4, 6, 8, and 10 are longitudinal aberration diagrams of the optical systems according to Examples 1 to 5, respectively. From the left, each longitudinal aberration diagram illustrates spherical aberration, curvature of field (astigmatism), and distortion. Each longitudinal aberration diagram illustrates aberration amounts for 656.3 nm (C-line), 587.6 nm (d-line), 486.1 nm (F-line), and 435.8 nm (g-line) with different lines.

A detailed description will be given of the characteristic of the optical system according to each example.

The optical system according to each example includes, in order from the object side to the image side, a front group G1 having negative refractive power, and a rear group G2 having positive refractive power. Now assume that the cover glass CG is not included in each optical system. The front group G1 includes, in order from the object side to the image side, a first lens L1 having negative refractive power, and a second lens L2 having an aspheric surface. An object-side surface of the first lens L1 is a convex surface. A second lens L2 has negative refractive power near the optical axis OA (on the optical axis). An object-side surface of the second lens L2 is a convex surface near the optical axis.

The rear group G2 includes, in order from the object side to the image side, a third lens L3 having positive refractive power, a fourth lens L4 having positive refractive power, a fifth lens L5 having negative refractive power, and a sixth lens L6 having an aspheric surface. The fourth lens L4 and the fifth lens L5 are cemented together to form a cemented lens CL. An object-side surface of the sixth lens L6 is concave surface near the optical axis. Here, a lens means an optical element with refractive power, and does not include optical elements such as parallel plate glass that do not have refractive power. The rear group G2 further includes an aperture stop STO.

In the optical system according to each example, the second lens L2 disposed at a position away from the aperture stop STO is an aspheric lens, and each example realizes a projection characteristic with high resolution in a central area of a screen (near the optical axis), and a wide angle of view by adopting the above lens configuration. Configuring the rear group G2 as described above can satisfactorily correct spherical aberration, on-axis aberration, and curvature of field that occur in a case where the optical system has a wide angle of view.

In each example, the following inequality (1) may be satisfied:

$$1. < f 3 / f < 1.8 \qquad ( 1 )$$

where f3 is a focal length of the third lens L3, and f is a focal length of the optical system (entire system).

In order to reduce the overall length of the optical system, it is effective to increase the power of the lens having positive refractive power disposed at a position where an on-axis ray height is high. In each example, since the first lens L1 and the second lens L2 have negative refractive power, the on-axis ray diverges and thus the incident position on the third lens L3 is high. Properly setting the third lens L3 having positive refractive power can reduce the overall length of the optical system. In a case where f3/f becomes higher than the upper limit of inequality (1), the positive refractive power of the third lens L3 becomes weak, and the effect of reducing the overall length is reduced. On the other hand, in a case where f3/f becomes lower than the lower limit of inequality (1), the positive refractive power of the third lens L3 becomes too strong, and it becomes difficult to correct curvature of field.

Inequality (1) may be replaced with inequality (1a) or (1b) below:

$$1.2 < f 3 / f < 1.75 \qquad ( 1 a )$$

$$1.3 < f 3 / f < 1.7 \qquad ( 1 b )$$

The optical system according to each example can obtain the effects of the present disclosure as long as it satisfies at least the above configuration, and the front group G1 may have a lens other than the first lens L1 and the second lens L2 (three or more lenses).

In each example, inequality (2) below may be satisfied:

$$1. < f \times sin ( θ max ) / y ( θ max ) \leq 1.9 \qquad ( 2 )$$

where θ [degree] is a half angle of view of the optical system, y(θ) is a projection characteristic that expresses a relationship between the half angle of view θ and an image height y, and θ max is a maximum half angle of view of the optical system.

Details will be described later, but configuring the optical system to satisfy inequality (2) can increase the resolution of an object image at an angle of view near the optical axis OA (near the optical axis) while a wide angle of view is maintained.

Inequality (2) may be replaced with inequality (2a) or (2b) below:

$$1. < f \times sin ( θ max ) / y ( θ max ) \leq 1.7 \qquad ( 2 a )$$

$$1. < f \times sin ( θ max ) / y ( θ max ) \leq 1.4 \qquad ( 2 b )$$

In each example, the following inequality (3) may be satisfied:

$$0.65 < y ( θ max / 2 ) / y ( θ max ) < 0.85 \qquad ( 3 )$$

A ratio of the image height y(θ max) at a maximum half angle of view θ max to an image height y(θ max/2) at an angle of view θ max/2, which is half the maximum half angle of view θ max, is set within the range of inequality (3). Thereby, the resolution of an object image can be increased at an angle of view near the optical axis OA while a wide angle of view is maintained.

Inequality (3) may be replaced with inequality (3a) or (3b) below:

$$0.65 < y ( θ max / 2 ) / y ( θ max ) < 0 \text{.83} \qquad ( 3 a )$$

$$0.65 < y ( θ max / 2 ) / y ( θ max ) < 0.81 \qquad ( 3 b )$$

An image pickup apparatus such as an on-board camera described later is demanded to have a wide angle of view, and to increase an imaging magnification near the optical axis (central area). For example, in a case where the image pickup apparatus is disposed at the rear of a movable apparatus (vehicle), an image corresponding to the central area, which is the main target area (reference area or area of interest), may be enlarged and displayed on an electronic rearview mirror, and an entire image including an area other than the central area (peripheral area) may be displayed on the in-vehicle display. Thus, the imaging magnification (focal length) of the optical system may be different between the central area and the other areas.

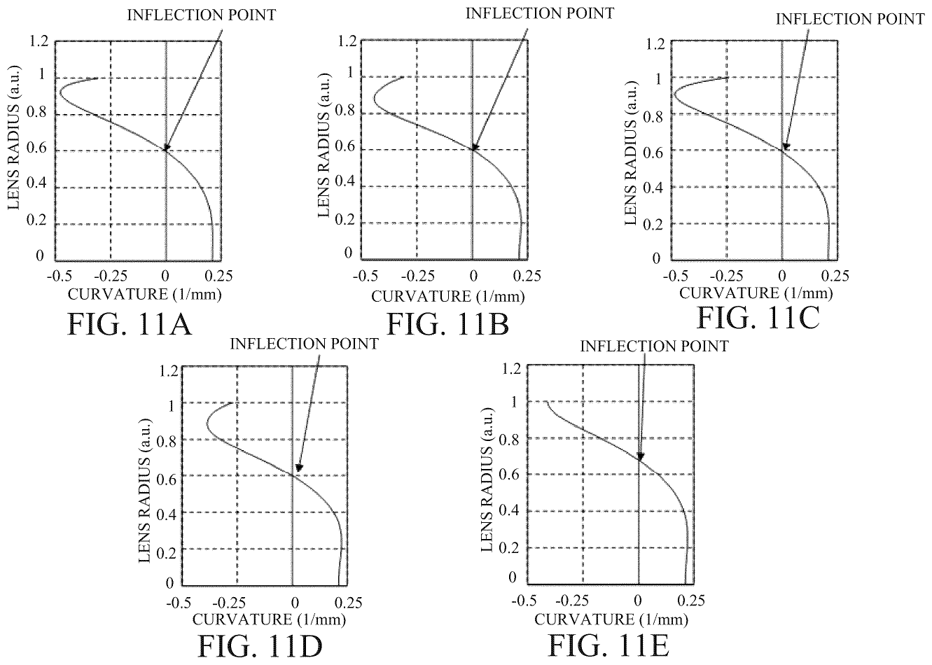

FIGS. 11A to 11E illustrate an aspheric shape of the object side of the second lens L2 in each example. In FIGS. 11A to 11E, a vertical axis indicates a radial position (lens radius) in a section having the optical axis OA of an object-side surface of the second lens L2, and a horizontal axis indicates a curvature [1/mm] of the object-side surface of the second lens L2. That is, FIGS. 11A to 11E are graphs plotting the curvatures for each position of the object-side surface of the second lens L2. The numerical values on the vertical axis indicate a distance (normalized distance) from the optical axis OA to each position within the effective diameter of the object-side surface of the second lens L2 in a case where the distance from the optical axis OA to the position of the effective diameter (maximum effective diameter) is normalized to be 1.

The object-side surface (lens object-side surface) of the second lens L2, which is an aspheric lens, can largely refract a light ray from the peripheral portion in the radial direction of a light beam from the first lens L1 toward the optical axis OA. Thereby, it becomes easy to make the imaging magnification different between the central area and the peripheral area of the optical system. In this case, the object-side surface of the second lens L2 may have an inflection point in a section having the optical axis OA, as illustrated in FIGS. 11A to 11E. Thereby, it becomes easy to widen an angle of view and increase the imaging magnification in the central area while the number of lenses in the optical system is reduced.

The following inequality (4) may be satisfied:

$$0.8 < t 23 / fR < 1.5 \qquad ( 4 )$$

where t23 is a distance (gap) on the optical axis from the image-side surface of the second lens L2 to the object-side surface of the third lens L3, and fR is a focal length of the rear group.

Generally, in a case where an optical system is divided into a front group and a rear group, power (refractive power) Φ of the optical system (entire system) is expressed by the following equation (5):

$$Φ = \frac{1}{{f}_{F}} + \frac{1}{{f}_{R}} - d \frac{1}{{f}_{F}} \frac{1}{{f}_{R}} \qquad ( 5 )$$

where f_{F} is a focal length of the front group, and d is a distance on the optical axis between the front group and the rear group.

In each example, the refractive power of the front group G1 is negative, and the refractive power of the rear group G2 is positive. Thus, the third term of equation (5) is positive, and the value of the third term increases as the distance between the front group G1 and the rear group G2 increases. In setting the power (or focal length) of the optical system (entire system) to a desired value, as the distance between the front group G1 and the rear group G2 increases, the value of the third term increases, and thus it is not necessary to excessively strengthen the power of the rear group G2 having positive refractive power. This is beneficial to aberration correction.

In a case where t23/fR becomes lower than the lower limit of inequality (4), the distance between the front group G1 and the rear group G2 becomes insufficient, so the refractive power of the rear group G2 becomes too strong, aberration correction becomes difficult. On the other hand, in a case where t23/fR becomes higher than the upper limit of inequality (4), the distance between the front group G1 and the rear group G2 becomes too wide, and the size of the optical system increases.

Inequality (4) may be replaced with (4a) or (4b) below:

$$0.81 < t 23 / fR < 1.35 \qquad ( 4 a )$$

$$0.82 < t 23 / fR < 1.2 \qquad ( 4 b )$$

The following inequality (6) may be satisfied:

$$1.2 < f 3 / f 4 < 1.7 \qquad ( 6 )$$

where f4 is a focal length of the fourth lens L4.

The third lens L3 and the fourth lens L4, which have positive refractive power, can suppress the occurrence of aberrations in each lens by sharing the optical power. In a case where f3/f4 becomes lower than the lower limit or higher than the upper limit of inequality (6), the power becomes biased toward one of the lenses, and it becomes difficult to correct spherical aberration and astigmatism.

Inequality (6) may be replaced with (6a) or (6b) below:

$$1.3 < f 3 / f 4 < 1.65 \qquad ( 6 a )$$

$$1.4 < f 3 / f 4 < 1.6 \qquad ( 6 b )$$

The following inequality (7) may be satisfied:

$$30 < v 3 < 100 \qquad ( 7 )$$

where ν3 is an Abbe number based on the d-line of the third lens L3.

In a case where v3 becomes lower than the lower limit of inequality (7), the occurrence of lateral chromatic aberration becomes too large, and aberration correction becomes difficult. On the other hand, in a case where v3 becomes higher than the upper limit of inequality (7), the material has a small dispersion, and manufacturing becomes difficult.

Inequality (7) may be replaced with (7a) or (7b) below:

$$40 < v 3 < 85 \qquad ( 7 a )$$

$$50 < v 3 < 70 \qquad ( 7 b )$$

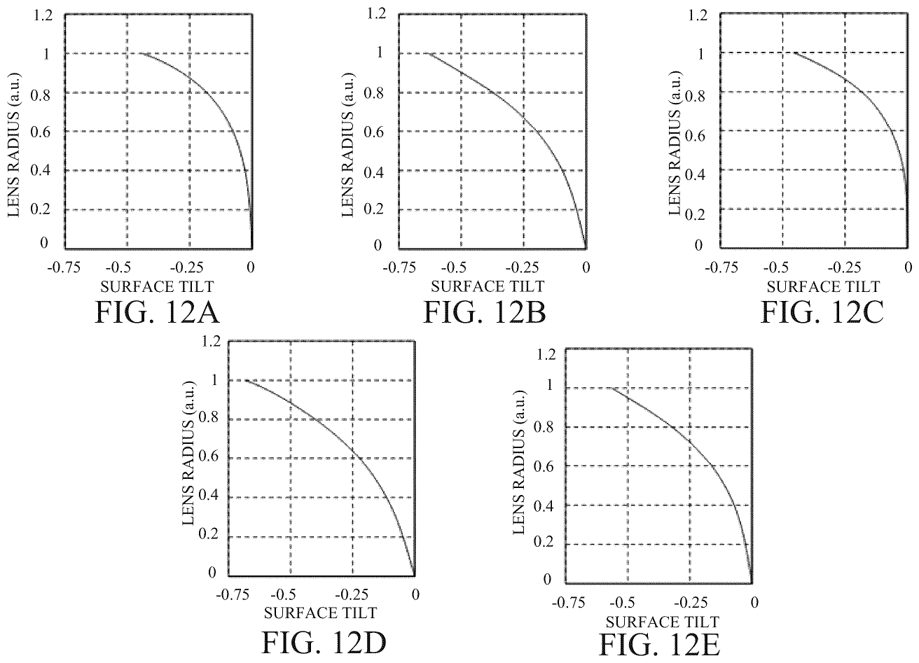

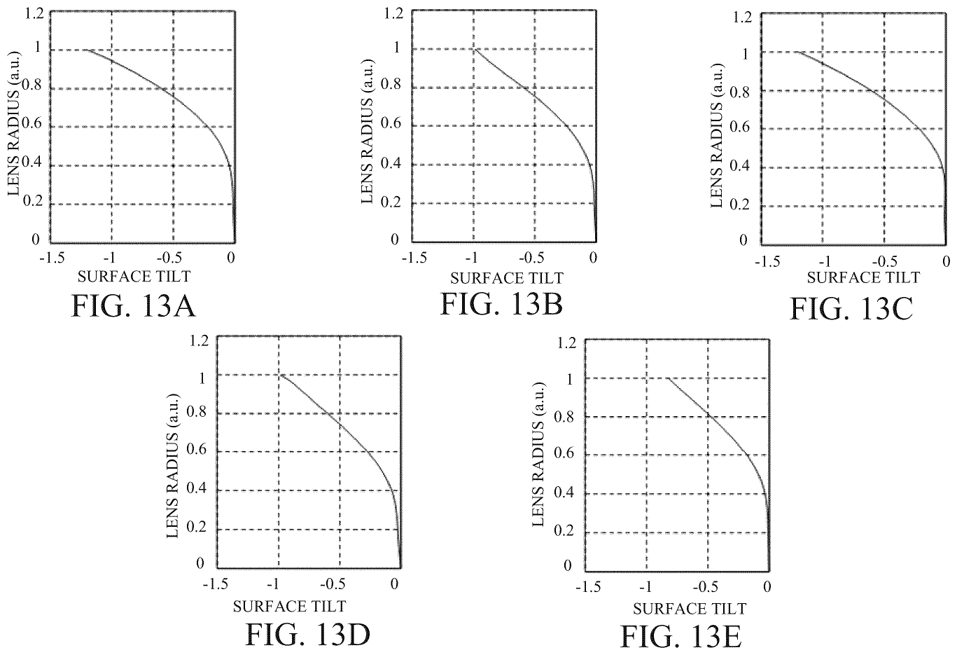

FIGS. 12A to 12E illustrate the tilt of the object-side surface of the sixth lens L6 in each example. FIGS. 13A to 13E illustrate the tilt of the image-side surface of the sixth lens L6 in each example. In FIGS. 12A to 12E and 13A to 13E, a vertical axis represents a position in a radial direction (lens radius) of each surface of the sixth lens L6 in a section having the optical axis OA, and a horizontal axis represents a differential value in the radial direction of the lens relative to a sag amount of the surface. The numerical values on the vertical axis illustrate a distance (normalized distance) from the optical axis OA to each position within the effective diameter of each surface of the sixth lens L6 in a case where the distance from the optical axis OA to the position of the effective diameter (maximum effective diameter) is normalized to be 1.

The object-side surface of the sixth lens L6 is aspheric, and it may not have an extreme value in the radial direction in a section having the optical axis OA. As illustrated in FIGS. 12A to 12E, the tilt of the object-side surface of the sixth lens L6 always has a negative value in the radial direction of the lens and has no extreme values. Therefore, no concave portion is formed on the surface, and this is beneficial to manufacturing.

The tilt of the object-side surface of the sixth lens L6 (tilt relative to a plane perpendicular to the optical axis OA) may increase monotonically in the radial direction in a section having the optical axis OA. More off-axis rays from the fifth lens L5 are more likely to obliquely incident on this surface, and as illustrated in FIGS. 12A to 12E, the negative value of the tilt of the object-side surface of the sixth lens L6 monotonically increases. Hence, the incident angle on this surface can be reduced and the occurrence of astigmatic difference can be suppressed.

The image-side surface of the sixth lens L6 may be aspheric and have no extreme values in the radial direction in a section having the optical axis OA. As illustrated in FIGS. 13A to 13E, the tilt of the image-side surface of the sixth lens L6 always has a negative value in the radial direction of the lens and has no extreme values, so no concave portion is formed on the surface. This is beneficial to manufacturing.

The tilt of the image-side surface of the sixth lens L6 may monotonically increase in the radial direction in a section having the optical axis OA. Off-axis rays from the object surface of the sixth lens L6 are obliquely incident on this surface, but as illustrated in FIGS. 13A to 13E, the negative value of the tilt of the image-side surface of the sixth lens L6 monotonically increases. Thus, the incident angle on this surface can be reduced and the occurrence of astigmatic differences can be suppressed.

The following inequality (8) may be satisfied:

$$- 0.3 < ( R 32 + R 31 ) / ( R 32 - R 31 ) < 0.15 \qquad ( 8 )$$

where R31 is a radius of curvature of an object-side surface of the third lens L3, and R32 is a radius of curvature of the image-side surface of the third lens L3.

In a case where (R32+R31)/(R32−R31) becomes higher than the upper limit of inequality (8), the spherical aberration generated by the third lens L3 is not shared between the object-side surface and the image-side surface, and it becomes sensitive to the occurrence of higher-order aberrations and manufacturing errors. On the other hand, in a case where (R32+R31)/(R32−R31) becomes lower than the lower limit of inequality (8), coma occurs more and is difficult to correct.

Inequality (8) may be replaced with (8a) or (8b) below:

$$- 0.3 < ( R 32 + R 31 ) / ( R 32 - R 31 ) < 0.12 \qquad ( 8 a )$$

$$- 0.3 < ( R 32 + R 31 ) / ( R 32 - R 31 ) < 0.1 \qquad ( 8 b )$$

The following inequality (9) may be satisfied:

$$- 6. < f 1 / f < - 3. \qquad ( 9 )$$

where f1 is a focal length of the first lens L1.

In a case where f1/f becomes higher than the upper limit of inequality (9), the negative refractive power of the first lens L1 becomes too strong, and various aberrations excessively occur in the first lens L1. On the other hand, in a case where f1/f becomes lower than the lower limit of inequality (9), the negative refractive power of the first lens L1 is too weak, and the occurrence of pupil aberrations is suppressed, and an off-axis light capturing amount is reduced.

Inequality (9) may be replaced with (9a) or (9b) below:

$$- 5.9 < f 1 / f < - 3.2 \qquad ( 9 a )$$

$$- 5.8 < f 1 / f < - 3.4 \qquad ( 9 b )$$

The image pickup apparatus includes an optical system according to each example configured to form an object image, and an image sensor configured to photoelectrically convert an object image (capture the object via the optical system). A plurality of pixels are two-dimensionally arranged on the imaging surface of the image sensor.

A description will be given of a detailed configuration of the optical system according to each example.

### Example 1

An optical system 100 according to Example 1 illustrated in FIG. 1 includes, in order from the object side to the image side, a first lens L1, a second lens L2, a third lens L3, an aperture stop STO, a fourth lens L4, a fifth lens L5, and a sixth lens L6. The first lens L1 is a meniscus lens having a convex object-side surface and negative refractive power. The second lens L2 is an aspheric lens. The third lens L3 and the fourth lens L4 are both biconvex lenses having positive refractive power. The fifth lens L5 is a meniscus lens having a convex image-side surface and negative refractive power. The sixth lens L6 is an aspheric lens.

The imaging surface of an image sensor such as a Complementary Metal-Oxide-Semiconductor (CMOS) sensor is disposed on the image plane IMG, and has a cover glass CG for the image sensor. In the image pickup apparatus, image data is generated from an output of the imaging sensor.

The fourth lens L4 and the fifth lens L5 are cemented together to form a cemented lens CL.

The object-side surface of the second lens L2 is convex near the optical axis OA (on the optical axis), and the image-side surface is concave. As illustrated in FIG. 11A, the object-side surface of the second lens L2 is an aspheric surface with an inflection point in a section having the optical axis OA. The object-side surface of the sixth lens L6 is concave near the optical axis, and as illustrated in FIG. 12A, the tilt of the surface does not have an extreme value in the radial direction in the section having the optical axis OA, and monotonically increases. The image-side surface of the sixth lens L6 is convex near the optical axis, and as illustrated in FIG. 13A, the tilt of the surface does not have an extreme value in the radial direction in the section having the optical axis OA, and monotonically increases.

The first lens L1 and the second lens L2 constitute a front group G1, and the focal length of the front group G1 is −5.01 mm. The third lens L3 to the sixth lens L6 constitute the rear group G2, and the focal length of the rear group G2 is 5.53 mm.

As illustrated in FIG. 2, the optical system 100 according to this example satisfactorily suppress spherical aberration and curvature of field at wavelengths of 400 to 700 nm. While distortion increases as an angle of view (image height) increases in the peripheral area, it is relatively reduced in the central area. Thereby, the resolution in the central area can be higher than that in the peripheral area, and the visibility of the image for the user of the image pickup apparatus can be improved as described above.

Numerical example 1 illustrates specific numerical values of the optical system 100 according to this example. Table 1 illustrates the numerical values of each inequality. The optical system 100 according to this example satisfies inequalities (1) to (4) and (6) to (9).

### Example 2

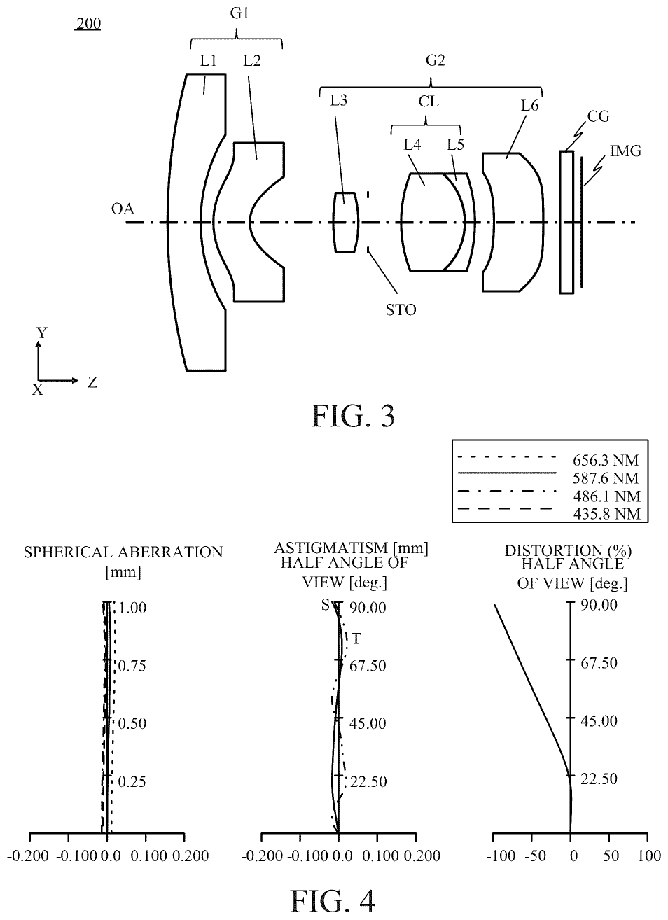

An optical system 200 according to Example 2 illustrated in FIG. 3 includes, in order from the object side to the image side, a first lens L1, a second lens L2, a third lens L3, an aperture stop STO, a fourth lens L4, a fifth lens L5, and a sixth lens L6. The first lens L1 is a meniscus lens having a convex object-side surface and L3 and the fourth lens L4 are both biconvex lenses with positive power (refractive power). The fifth lens L5 is a meniscus lens with a convex image-side surface and negative power. The sixth lens L6 is an aspheric lens.

The imaging surface of an image sensor such as a CMOS sensor is disposed on the image plane IMG, and has a cover glass CG of the image sensor. In the image pickup apparatus, image data is generated from an output of the image sensor.

The fourth lens L4 and the fifth lens L5 are cemented together to form a cemented lens CL.

The object-side surface of the second lens L2 is convex near the optical axis, and the image-side surface is concave. As illustrated in FIG. 11B, the object-side surface of the second lens L2 is an aspheric surface with an inflection point in a section having the optical axis OA. The object-side surface of the sixth lens L6 is concave near the optical axis, and as illustrated in FIG. 12B, the tilt of the surface does not have an extreme value in the radial direction in the section having the optical axis OA, and monotonically increases. The image-side surface of the sixth lens L6 is convex near the optical axis, and as illustrated in FIG. 13B, the tilt of the surface does not have an extreme value in the radial direction in the section having the optical axis OA, and monotonically increases.

The first lens L1 and the second lens L2 constitute the front group G1, and the focal length of the front group G1 is −5.52 mm. The third lens L3 to the sixth lens L6 constitute the rear group G2, and the focal length of the rear group G2 is 6.75 mm.

As illustrated in FIG. 4, the optical system 200 according to this example satisfactorily suppresses spherical aberration and curvature of field in the wavelength range of 400 to 700 nm. While distortion increases as an angle of view (image height) increases in the peripheral area, it is relatively reduced in the central area. Thereby, the resolution in the central area can be higher than that in the peripheral area, and the visibility of the image for the user of the image pickup apparatus can be improved as described above.

Numerical example 2 illustrates specific numerical values of the optical system 200 according to this example. Table 1 illustrates the numerical values of each inequality. The optical system 200 according to this example satisfies inequalities (1) to (4) and (6) to (9).

### Example 3

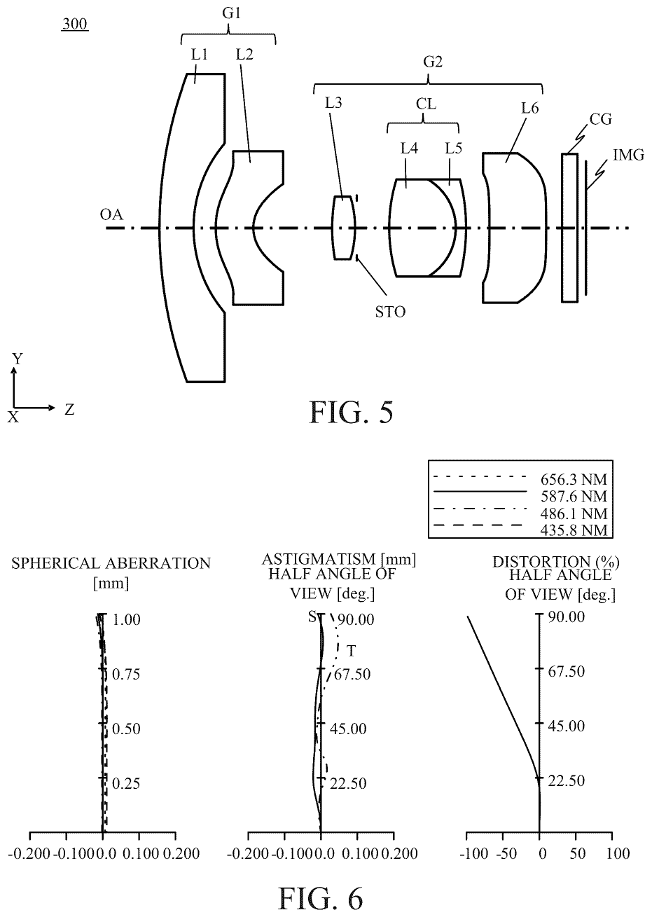

An optical system 300 according to Example 3 illustrated in FIG. 5 includes, in order from the object side to the image side, a first lens L1, a second lens L2, a third lens L3, an aperture stop STO, a fourth lens L4, a fifth lens L5, and a sixth lens L6. The first lens L1 is a meniscus lens having a convex object-side surface and negative refractive power. The second lens L2 is an aspheric lens. The third lens L3 and the fourth lens L4 are both biconvex lenses with positive power (refractive power). The fifth lens L5 is a meniscus lens with negative power having a convex image-side surface. The sixth lens L6 is an aspheric lens.

The image pickup surface of an image sensor such as a CMOS sensor is disposed on the image plane IMG, and has a cover glass CG of the image sensor. In the image pickup apparatus, image data is generated from an output of the image sensor.

The fourth lens L4 and the fifth lens L5 are cemented together to form a cemented lens CL.

The object-side surface of the second lens L2 is a convex surface near the optical axis, and the image-side surface is a concave surface. As illustrated in FIG. 11C, the object-side surface of the second lens L2 is an aspheric surface with an inflection point in a section having the optical axis OA. The object-side surface of the sixth lens L6 is concave near the optical axis, and as illustrated in FIG. 12C, the tilt of the surface does not have an extreme value in the radial direction in the section having the optical axis OA, and monotonically increases. The image-side surface of the sixth lens L6 is convex near the optical axis, and as illustrated in FIG. 13C, the tilt of the surface does not have an extreme value in the radial direction in the section having the optical axis OA, and monotonically increases.

The first lens L1 and the second lens L2 constitute the front group G1, and the focal length of the front group G1 is −5.07 mm. The third lens L3 to the sixth lens L6 constitute the rear group G2, and the focal length of the rear group G2 is 5.58 mm.

As illustrated in FIG. 6, the optical system 300 according to this example satisfactorily suppresses spherical aberration and curvature of field in the wavelength range of 400 to 700 nm. While distortion increases as an angle of view (image height) increases in the peripheral area, it is relatively reduced in the central area. Thereby, the resolution in the central area can be higher than that in the peripheral area, and the visibility of the image for the user of the image pickup apparatus can be improved as described above.

Numerical example 3 illustrates specific numerical values of the optical system 300 according to this example. Table 1 illustrates the numerical values of each inequality. The optical system 300 according to this example satisfies inequalities (1) to (4) and (6) to (9).

### Example 4

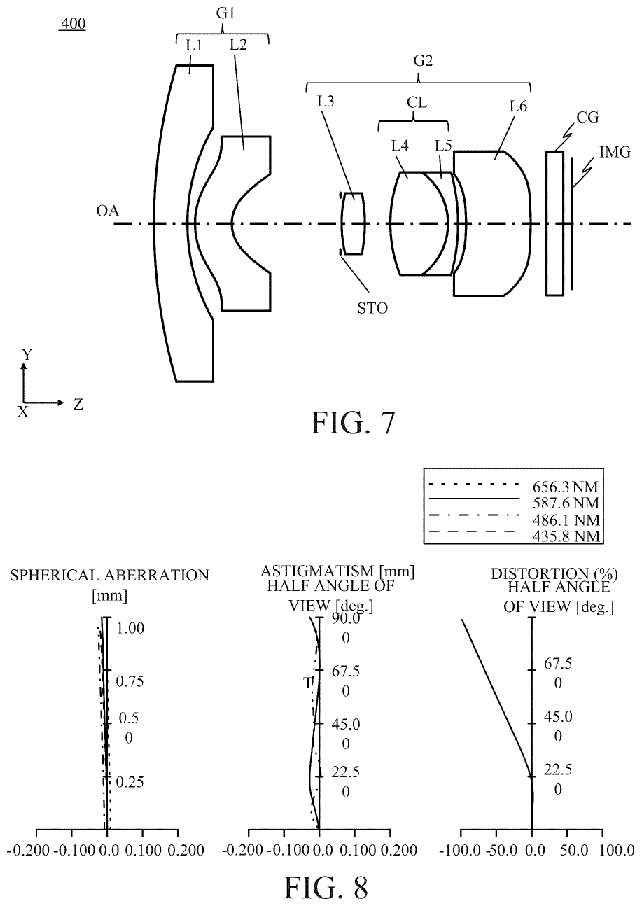

An optical system 400 according to Example 4 illustrated in FIG. 7 includes, in order from the object side to the image side, a first lens L1, a second lens L2, an aperture stop STO, a third lens L3, a fourth lens L4, a fifth lens L5, and a sixth lens L6. The first lens L1 is a meniscus lens having a convex object-side surface and L3 and the fourth lens L4 are both biconvex lenses with positive power (refractive power). The fifth lens L5 is a meniscus lens having a convex image-side surface and negative power. The sixth lens L6 is an aspheric lens.

The image pickup apparatus includes an imaging surface of an image sensor such as a CMOS sensor disposed on the image plane IMG, and a cover glass CG of the image sensor. Image data is generated from an output of the image sensor in the image pickup apparatus.

The fourth lens L4 and the fifth lens L5 are cemented together to form a cemented lens CL.

The object-side surface of the second lens L2 is convex near the optical axis, and the image-side surface is concave. As illustrated in FIG. 11D, the object-side surface of the second lens L2 is an aspheric surface with an inflection point in a section having the optical axis OA. The object-side surface of the sixth lens L6 is concave near the optical axis, and as illustrated in FIG. 12D, the tilt of the surface does not have an extreme value in the radial direction in the section having the optical axis OA, and monotonically increases. The image-side surface of the sixth lens L6 is convex near the optical axis, and as illustrated in FIG. 13D, the tilt of the surface does not have an extreme value in the radial direction in the section having the optical axis OA, and monotonically increases.

The first lens L1 and the second lens L2 constitute the front group G1, and the focal length of the front group G1 is −6.53 mm. The third lens L3 to the sixth lens L6 constitute the rear group G2, and the focal length of the rear group G2 is 5.59 mm.

As illustrated in FIG. 8, the optical system 400 according to this example satisfactorily suppresses spherical aberration and curvature of field in the wavelength range of 400 to 700 nm. While distortion increases as an angle of view (image height) increases in the peripheral area, it is relatively reduced in the central area. Thereby, the resolution in the central area can be higher than that in the peripheral area, and the visibility of the image for the user of the image pickup apparatus can be improved as described above.

Numerical example 4 illustrates specific numerical values of the optical system 400 according to this example. Table 1 illustrates the numerical values of each inequality. The optical system 400 according to this example satisfies the inequalities (1) to (4) and (6) to (9).

### Example 5

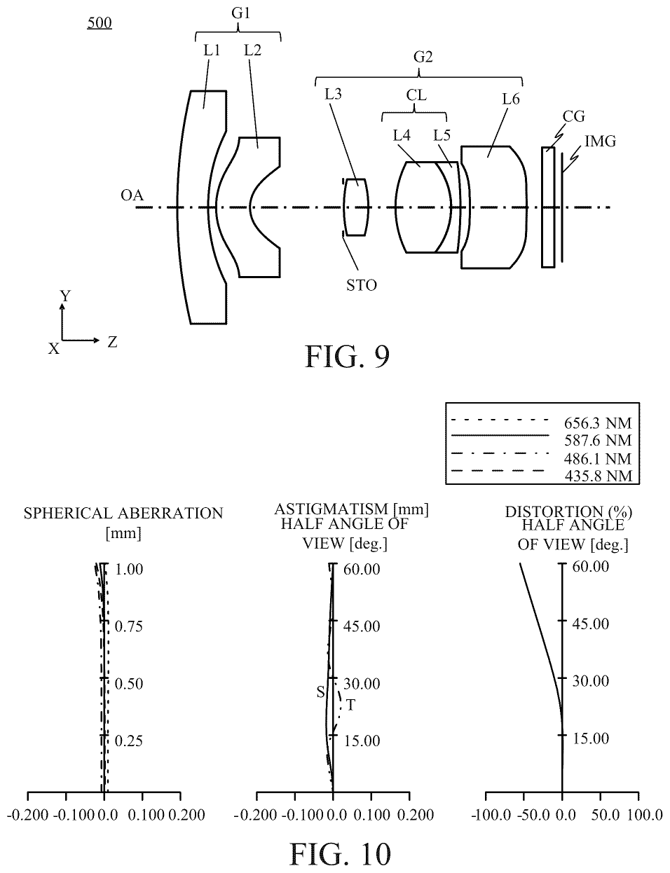

An optical system 500 according to Example 5 illustrated in FIG. 9 includes, in order from the object side to the image side, a first lens L1, a second lens L2, an aperture stop STO, a third lens L3, a fourth lens L4, a fifth lens L5, and a sixth lens L6. The first lens L1 is a meniscus lens having a convex object-side surface and negative refractive power. The second lens L2 is an aspheric lens. The third lens L3 and the fourth lens L4 are both biconvex lenses with positive power (refractive power). The fifth lens L5 is a meniscus lens with a convex image-side surface and negative power. The sixth lens L6 is an aspheric lens.

The imaging surface of an image sensor such as a CMOS sensor is disposed on the image plane IMG, and has a cover glass CG of the image sensor. In the image pickup apparatus, image data is generated from an output of the image sensor.

The fourth lens L4 and the fifth lens L5 are cemented together to form a cemented lens CL.

The object-side surface of the second lens L2 is convex near the optical axis, and the image-side surface is concave. As illustrated in FIG. 11E, the object-side surface of the second lens L2 is an aspheric surface with an inflection point in a section having the optical axis OA. The object-side surface of the sixth lens L6 is concave near the optical axis, and as illustrated in FIG. 12E, the tilt of the surface does not have an extreme value in the radial direction in the section having the optical axis OA, and monotonically increases. The image-side surface of the sixth lens L6 is convex near the optical axis, and as illustrated in FIG. 13E, the tilt of the surface does not have an extreme value in the radial direction in the section having the optical axis OA, and monotonically increases.

The first lens L1 and the second lens L2 constitute the front group G1, and the focal length of the front group G1 is −6.16 mm. The third lens L3 to the sixth lens L6 constitute the rear group G2, and the focal length of the rear group G2 is 5.39 mm.

As illustrated in FIG. 10, the optical system 500 according to this example satisfactorily suppresses spherical aberration and curvature of field in the wavelength range of 400 to 700 nm. While distortion increases as an angle of view (image height) increases in the peripheral area, it is relatively reduced in the central area. Thereby, the resolution in the central area can be higher than that in the peripheral area, and the visibility of the image for the user of the image pickup apparatus can be improved as described above.

Numerical example 5 illustrates specific numerical values of the optical system 500 according to this example. Table 1 illustrates the numerical values of each inequality. The optical system 500 according to this example satisfies inequalities (1) to (4) and (6) to (9).

A description will now be given of numerical examples 1 to 5 corresponding to Examples 1 to 5, respectively. In each numerical example, i represents the order of a surface (optical surface) counted from the object side. ri represents a radius of curvature of an i-th surface (unit: mm), di represents a distance between i-th and (i+1)-th surfaces (unit: mm), and ndi and vdi represent a refractive index and Abbe number of the i-th optical member based on the d-line (wavelength 587.6 nm). The Abbe number νd is defined by the following equation:

$$vd = ( nd - 1 ) / ( nF - nC )$$

where nF, nd, and nC are refractive indices for the F-line, d-line, and C-line, respectively.

The surface distance (or separation) is positive if the direction moves toward the image side along the optical path, and the surface distance is negative if the direction moves toward the object side. In numerical examples 1 to 5, the two surfaces closest to the image plane are flat surfaces that correspond to the optical block.

In a case where an optical surface is aspheric, an asterisk “*” is added to the right of the surface number. Each of the aspheric optical surfaces in this example is rotationally symmetric about the optical axis, and is expressed by the following aspheric expression:

$$z = \frac{{ch}^{2}}{1 + \sqrt{1 - ( 1 + k ) {c}^{2} {h}^{2}}} + {Ah}^{4} + {Bh}^{6} + {Ch}^{8} + {Dh}^{10} + {Eh}^{12} + {Fh}^{14} + {Gh}^{16} + …$$

where z is a sag amount (mm) of an aspheric shape in the optical axis direction, c is a curvature (1/mm) on the optical axis AX, k is a cone coefficient, h is a distance (mm) in the radial direction from the optical axis OA, and A, B, C, . . . are aspheric coefficients of the fourth order term, sixth order term, eighth order term, . . . respectively. In this aspheric equation, the first term indicates the sag amount of a base sphere, and a radius of curvature of this base sphere is R=1/c. The second and subsequent terms indicate the sag amount of the aspheric component applied to the base sphere. In each numerical example, “E±P” means “×10^{±P}.”

The optical system according to each numerical example is a single focus optical system in which a focal length is fixed (no zooming is performed) and no focusing is performed. In other words, a distance between the lenses in the optical system according to each numerical example is always fixed. Thereby, fluctuations in optical performance can be avoided along with the movement of each lens. However, if necessary, the optical system may be configured to perform at least one of zooming and focusing, and a distance between the lenses may be configured to change for this purpose.

### Numerical Example 1

SURFACE DATA

| Surface No. | r | d | nd | νd |
|---|---|---|---|---|
| 1 | 32.135 | 2.00 | 1.703 | 52.4 |
| 2 | 8.988 | 1.00 | | |
| 3* | 4.779 | 2.20 | 1.583 | 59.5 |
| 4* | 2.002 | 4.82 | | |
| 5 | 8.502 | 1.41 | 1.639 | 55.4 |
| 6 | −7.468 | 0.31 | | |
| 7 (STO) | ∞ | 1.90 | | |
| 8 | 9.144 | 3.35 | 1.595 | 67.7 |
| 9 | −3.329 | 0.62 | 1.847 | 23.8 |
| 10 | −10.605 | 0.86 | | |
| 11* | −71.758 | 4.22 | 1.583 | 59.5 |
| 12* | −34.349 | 0.87 | | |
| 13 | ∞ | 1.00 | 1.560 | 56.0 |
| 14 | ∞ | 0.50 | | |
| 15 (IMG) | ∞ | | | |

ASPHERIC DATA

| Surface | | | | |
|---|---|---|---|---|
| No. | K | A | B | C |
| 3 | −3.9571E+00 | 5.0632E−03 | −5.8613E−04 | 3.0001E−05 |
| 4 | −5.9485E−01 | 5.2028E−03 | −2.2066E−03 | 9.7470E−05 |
| 11 | 0.0000E+00 | −8.3736E−04 | −1.3504E−03 | 4.4466E−04 |
| 12 | 0.0000E+00 | 5.6639E−03 | −2.2098E−03 | 2.8026E−04 |
| | D | E | F | G |
| 3 | −2.7899E−06 | 2.1270E−07 | −8.0836E−09 | 1.2197.E−10 |
| 4 | −4.0398E−05 | 1.3020E−05 | −1.9419E−06 | 1.0674.E−07 |
| 11 | −8.3883E−05 | 8.3421E−06 | −4.0932E−07 | 6.9235.E−09 |
| 12 | −2.2691E−05 | 1.1328E−06 | −3.1237E−08 | 3.5844.E−10 |

VARIOUS DATA

| | |
|---|---|
| Focal Length (mm) | 4.53 |
| Fno | 2.80 |
| Half Angle of View (deg.) | 90.0 |
| Overall Length (mm) | 25.05 |

### Numerical Example 2

SURFACE DATA

| Surface No. | r | d | nd | νd |
|---|---|---|---|---|
| 1 | 34.938 | 2.00 | 1.703 | 52.4 |
| 2 | 10.110 | 0.77 | | |
| 3* | 4.750 | 2.20 | 1.583 | 59.5 |
| 4* | 2.054 | 5.03 | | |
| 5 | 11.194 | 1.51 | 1.589 | 61.1 |
| 6 | −6.610 | 0.58 | | |
| 7 (STO) | ∞ | 2.00 | | |
| 8 | 7.974 | 3.85 | 1.618 | 63.3 |
| 9 | −3.898 | 0.60 | 1.893 | 20.4 |
| 10 | −8.919 | 1.15 | | |
| 11* | −15.532 | 2.98 | 1.583 | 59.5 |
| 12* | −28.493 | 1.01 | | |
| 13 | ∞ | 0.80 | 1.560 | 56.0 |
| 14 | ∞ | 0.50 | | |
| 15 (IMG) | ∞ | | | |

ASPHERIC DATA

| Surface No. | K | A | B | C |
|---|---|---|---|---|
| 3 | −3.2078E+00 | 5.8684E−03 | −7.2302E−04 | 6.7335E−05 |
| 4 | −5.2267E−01 | 7.6289E−03 | −2.5226E−03 | 1.0393E−04 |
| 11 | 0.0000E+00 | −5.9387E−04 | −2.4198E−03 | 7.6714E−04 |
| 12 | 0.0000E+00 | 8.6149E−03 | −4.1195E−03 | 6.6355E−04 |
| | D | E | F | G |
| 3 | −7.5321E−06 | 4.8581E−07 | −1.5022E−08 | 1.7928.E−10 |
| 4 | −2.1161E−06 | −9.2832E−06 | 1.9917E−06 | −1.2574.E−07 |
| 11 | −1.3401E−04 | 1.2410E−05 | −5.4646E−07 | 8.1343.E−09 |
| 12 | −6.3876E−05 | 3.6376E−06 | −1.1135E−07 | 1.4060.E−09 |

VARIOUS DATA

| | |
|---|---|
| Focal Length (mm) | 4.50 |
| Fno | 2.80 |
| Half Angle of View (deg.) | 90.0 |
| Overall Length (mm) | 24.98 |

### Numerical Example 3

SURFACE DATA

| Surface No. | r | d | nd | νd |
|---|---|---|---|---|
| 1 | 26.038 | 2.00 | 1.703 | 52.4 |
| 2 | 7.679 | 1.30 | | |
| 3* | 4.812 | 2.20 | 1.583 | 59.5 |
| 4* | 2.127 | 4.63 | | |
| 5 | 10.499 | 1.34 | 1.603 | 60.6 |
| 6 | −6.153 | 0.10 | | |
| 7 (STO) | ∞ | 1.90 | | |
| 8 | 9.568 | 3.91 | 1.618 | 63.3 |
| 9 | −3.300 | 0.60 | 1.847 | 23.8 |
| 10 | −11.555 | 1.37 | | |
| 11* | −202.515 | 3.33 | 1.583 | 59.5 |
| 12* | −29.735 | 0.93 | | |
| 13 | ∞ | 0.90 | 1.560 | 56.0 |
| 14 | ∞ | 0.50 | | |
| 15 (IMG) | ∞ | | | |

ASPHERIC DATA

| Surface No. | K | A | B | C |
|---|---|---|---|---|
| 3 | −3.2011E+00 | 4.3512E−03 | −3.1831E−04 | −3.9417E−05 |
| 4 | −4.9624E−01 | 4.2044E−03 | 1.9513E−04 | −1.4432E−03 |
| 11 | 0.0000E+00 | 9.8265E−04 | −1.6503E−03 | 3.6134E−04 |
| 12 | 0.0000E+00 | 1.1233E−02 | −3.8988E−03 | 5.1119E−04 |
| | D | E | F | G |
| 3 | 5.4456E−06 | −3.0417E−07 | 8.6181E−09 | −9.4548.E−11 |
| 4 | 4.3074E−04 | −5.9822E−05 | 3.3205E−06 | −1.9937.E−08 |
| 11 | −4.1290E−05 | 1.8553E−06 | 1.6565E−08 | −2.7170.E−09 |
| 12 | −4.0265E−05 | 1.8953E−06 | −4.8930E−08 | 5.3120.E−10 |

### Various Data

| | |
|---|---|
| Focal Length (mm) | 4.51 |
| Fno | 2.80 |
| Half Angle of View (deg.) | 90.0 |
| Overall Length (mm) | 25.02 |

### Numerical Example 4

SURFACE DATA

| Surface No. | r | d | nd | νd |
|---|---|---|---|---|
| 1 | 34.209 | 2.00 | 1.703 | 52.4 |
| 2 | 11.603 | 0.45 | | |
| 3* | 4.774 | 2.20 | 1.583 | 59.5 |
| 4* | 2.172 | 6.51 | | |
| 5 (STO) | ∞ | 0.06 | | |
| 6 | 7.945 | 1.39 | 1.639 | 55.4 |
| 7 | −9.380 | 1.52 | | |
| 8 | 8.217 | 3.46 | 1.618 | 63.3 |
| 9 | −3.801 | 0.60 | 1.893 | 20.4 |
| 10 | −11.556 | 0.48 | | |
| 11* | −12.241 | 3.87 | 1.583 | 59.5 |
| 12* | −20.824 | 0.95 | | |
| 13 | ∞ | 1.00 | 1.560 | 56.0 |
| 14 | ∞ | 0.50 | | |
| 15 (IMG) | ∞ | | | |

ASPHERIC DATA

| Surface No. | K | A | B | C |
|---|---|---|---|---|
| 3 | −3.4765E+00 | 5.7781E−03 | −3.3546E−04 | 1.4620E−06 |
| 4 | −5.1905E−01 | 5.7961E−03 | 7.3257E−04 | −1.0837E−03 |
| 11 | 0.0000E+00 | −1.1472E−03 | −2.4170E−03 | 9.1354E−04 |
| 12 | 0.0000E+00 | 8.4354E−03 | −3.6764E−03 | 5.4299E−04 |
| | D | E | F | G |
| 3 | −7.9186E−07 | 9.2678E−08 | −3.2853E−09 | 3.9399.E−11 |
| 4 | 2.5070E−04 | −3.5513E−05 | 2.8905E−06 | −1.0453.E−07 |
| 11 | −1.9869E−04 | 2.4179E−05 | −1.5176E−06 | 3.7679.E−08 |
| 12 | −4.6569E−05 | 2.3197E−06 | −6.0101E−08 | 5.9285.E−10 |

VARIOUS DATA

| | |
|---|---|
| Focal Length (mm) | 4.50 |
| Fno | 2.80 |
| Half Angle of View (deg.) | 90.0 |
| Overall Length (mm) | 24.99 |

### Numerical Example 5

SURFACE DATA

| Surface No. | r | d | nd | νd |
|---|---|---|---|---|
| 1 | 32.807 | 2.00 | 1.703 | 52.4 |
| 2 | 11.088 | 0.52 | | |
| 3* | 4.753 | 2.20 | 1.583 | 59.5 |
| 4* | 2.107 | 6.04 | | |
| 5 (STO) | ∞ | 0.05 | | |
| 6 | 8.182 | 1.59 | 1.518 | 58.9 |
| 7 | −7.016 | 1.77 | | |
| 8 | 6.468 | 3.61 | 1.618 | 63.3 |
| 9 | −4.623 | 0.60 | 1.893 | 20.4 |
| 10 | −21.471 | 0.62 | | |
| 11* | −21.926 | 3.68 | 1.583 | 59.5 |
| 12* | −47.506 | 1.00 | | |
| 13 | ∞ | 0.80 | 1.560 | 56.0 |
| 14 | ∞ | 0.50 | | |
| 15 (IMG) | ∞ | | | |

ASPHERIC DATA

| Surface No. | K | A | B | C |
|---|---|---|---|---|
| 3 | −2.9034E+00 | 4.8820E−03 | −3.0036E−04 | 6.5621E−06 |
| 4 | −5.2350E−01 | 5.9449E−03 | 2.2764E−04 | −8.0585E−04 |
| 11 | 0.0000E+00 | −2.9052E−03 | −1.4403E−03 | 4.2903E−04 |
| 12 | 0.0000E+00 | 4.8230E−03 | −2.3005E−03 | 2.3993E−04 |
| | D | E | F | G |
| 3 | −1.7356E−06 | 1.5460E−07 | −5.1659E−09 | 6.1697.E−11 |
| 4 | 1.6304E−04 | −2.1492E−05 | 1.7398E−06 | −6.7600.E−08 |
| 11 | −7.3305E−05 | 6.5268E−06 | −2.5091E−07 | 2.0664.E−09 |
| 12 | −1.0497E−05 | −6.8424E−08 | 2.2720E−08 | −5.7428.E−10 |

VARIOUS DATA

| | |
|---|---|
| Focal Length (mm) | 4.52 |
| Fno | 2.80 |
| Half Angle of View (deg.) | 60.0 |
| Overall Length (mm) | 24.95 |

TABLE 1

| | EXAM- | EXAM- | EXAM- | EXAM- | EXAM- |
|---|---|---|---|---|---|
| INEQUALITY | PLE 1 | PLE 2 | PLE 3 | PLE 4 | PLE 5 |
| (1) | 1.419 | 1.614 | 1.467 | 1.542 | 1.669 |
| (2) | 1.155 | 1.149 | 1.152 | 1.150 | 1.290 |
| (3) | 0.794 | 0.782 | 0.783 | 0.778 | 0.668 |
| (4) | 0.872 | 0.894 | 0.830 | 1.178 | 1.131 |
| (6) | 1.414 | 1.505 | 1.476 | 1.471 | 1.517 |
| (7) | 55.379 | 61.134 | 60.640 | 55.379 | 58.901 |
| (8) | −0.065 | −0.257 | −0.261 | 0.083 | −0.077 |
| (9) | −4.050 | −4.639 | −3.585 | −5.748 | −5.467 |

### Image Pickup Apparatus

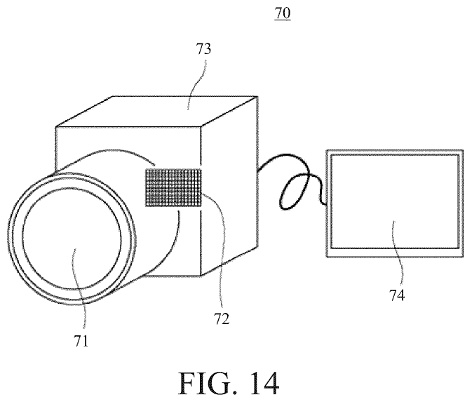

FIG. 14 is a schematic diagram of main parts of an image pickup apparatus 70 according to this example. The image pickup apparatus 70 according to this example includes an optical system (imaging optical system) 71 according to any one of the above examples, a light receiving element 72 configured to photoelectrically convert an object image formed by the optical system 71, and a camera body (housing) 73 configured to hold the light receiving element 72. The optical system 71 is held by a lens barrel (holder) and connected to the camera body 73. As illustrated in FIG. 14, a display unit 74 configured to display an image acquired by the light receiving element 72 may be connected to the camera body 73. An image sensor (photoelectric conversion element) such as a CCD sensor or a CMOS sensor can be used as the light receiving element 72.

In a case where the image pickup apparatus 70 is used as a distance measuring apparatus, for example, an image sensor (imaging-surface phase-difference sensor) having pixels that can split a light beam from the object side into two and photoelectrically convert it can be used as the light receiving element 72. In a case where the object is located on a front focal plane of the optical system 71, no positional shift occurs between images corresponding to the two split light beams on the image plane of the optical system 71. However, in a case where the object is located at a position other than the front focal plane of the optical system 71, a positional shift occurs between the images. In this case, a positional shift of each image corresponds to a displacement amount from the front focal plane of the object, so a distance to the object can be measured by acquiring a positional shift amount and a positional shift direction of each image using an imaging-surface phase-difference sensor.

The optical system 71 and the camera body 73 may be attachable to and detachable from each other. That is, the optical system 71 and the lens barrel may be configured as an interchangeable lens (lens apparatus). The optical system according to each of the above examples can be applied not only to image pickup apparatuses such as digital still cameras, film-based cameras, video cameras, on-board cameras, and surveillance cameras, but also to various optical apparatuses such as telescopes, binoculars, projectors (projection apparatuses), and digital copiers.

### On-Board System

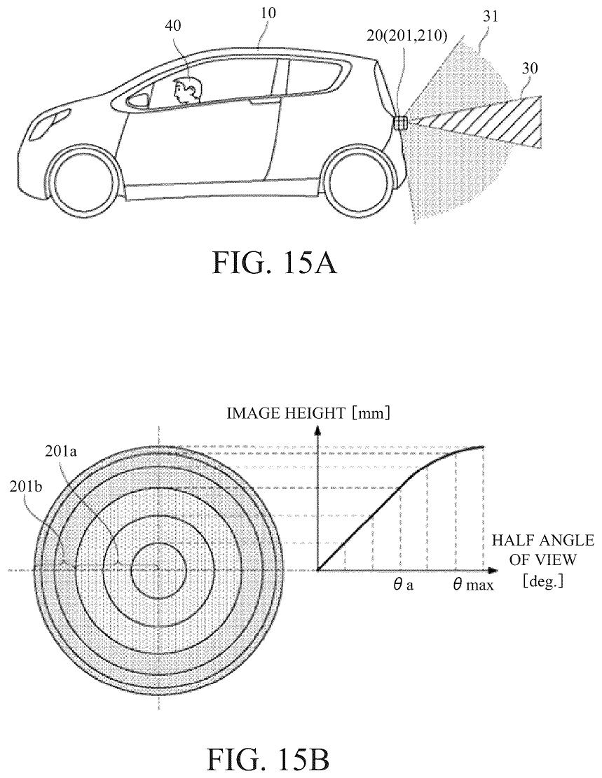

FIG. 15A is a schematic diagram of a movable apparatus 10 according to this embodiment and an image pickup apparatus 20 (on-board camera) held by it. FIG. 15A illustrates a case where the movable apparatus 10 is an automobile (vehicle). The movable apparatus 10 includes an unillustrated in-vehicle system (driving support device) for supporting a user 40 (driver, passenger, etc.) of the movable apparatus 10 using an image acquired by the image pickup apparatus 20. In this embodiment, the image pickup apparatus 20 is installed so as to image the rear of the movable apparatus 10, but the image pickup apparatus 20 may be installed so as to capture the front or side of the movable apparatus 10. In addition, two or more image pickup apparatuses 20 may be installed at two or more locations on the movable apparatus 10. The image pickup apparatus 20 includes an optical system 201 and an imaging unit 210 according to any of the above examples. The optical system 201 is an optical system (different-angle-of-view lens) in which an imaging magnification at a first angle of view (first field of view) 30 and an imaging magnification at a second angle of view (second field of view) 31 larger than the first angle of view 30 are different. The imaging surface (light receiving surface) of the imaging unit 210 includes a first area for imaging an object included in the first angle of view 30 and a second area for imaging an object included in the second angle of view 31. In this case, the number of pixels per unit angle of view in the first area is larger than the number of pixels per unit angle of view in the second area excluding the first area. In other words, the resolution of the image pickup apparatus 20 at the first angle of view (in the first area) is higher than the resolution at the second angle of view (in the second area).

A detailed description will now be given of the optical characteristic of the optical system 201. A left diagram in FIG. 15B illustrates an image height y [mm] at each half angle of view θ [deg.] on the imaging surface of the imaging unit 210 in the form of contour lines. A right diagram in FIG. 15B illustrates a relationship between each half angle of view θ and image height y in the first quadrant of the left diagram (projection characteristic of the optical system 201) in a graph.

As illustrated in FIG. 15B, the optical system 201 is configured such that the projection characteristic y(θ) differs between an angle of view less than a predetermined half angle of view θa and an angle of view equal to or larger than the half angle of view θa. Therefore, an increase amount in image height y per unit relative to a half angle of view θ (resolution) also differs for each angle of view. The local resolution of the optical system 201 is expressed as a differential value dy(θ)/dθ of the projection characteristic y(θ) relative to the half angle of view θ. In the left diagram of FIG. 15B, as an interval between the contour lines of the image height y relative to each half angle of view θ increases, the resolution becomes higher. In the right diagram of FIG. 15B, as a slope of the graph of the projection characteristic y(θ) increases, the resolution becomes higher.

In the left diagram of FIG. 15B, a first area 201a, which is a central area, corresponds to an angle of view less than the half angle of view θa, and a second area 201b, which is a peripheral area, corresponds to an angle of view equal to or larger than the half angle of view θa. The angle of view less than the half angle of view θa corresponds to the first angle of view 30 in FIG. 15A, and the angle of view obtained by combining the angle of view less than the half angle of view θa and the angle of view equal to or larger than the half angle of view θa corresponds to the second angle of view 31 in FIG. 11A. As described above, the first area 201a is an area with high resolution and low distortion, and the second area 201b is an area with low resolution and high distortion.

The optical system 201 is configured such that the projection characteristic y(θ) in the first area 201a is different from that of the equidistant projection method and is also different from that of the second area 201b. In this case, the projection characteristic y(θ) of the optical system 201 may satisfy inequality (2).

Satisfying inequality (2) can reduce the resolution in the second area 201b, and thereby realize a wide angle of view of the optical system 201. The resolution can be higher in the first area 201a than in the central area of a general fisheye lens that employs the orthogonal projection method. In a case where the value becomes lower than the lower limit of inequality (2), the resolution in the first area 201a becomes lower than that of a fisheye lens that employs the orthogonal projection method, or a maximum image height becomes larger. In a case where the value becomes higher than the upper limit of inequality (2), the resolution in the first area 201a becomes too high, and it becomes difficult to achieve a wide angle of view equivalent to that of a fisheye lens that employs the orthogonal projection method, or good optical performance cannot be maintained.

As described above, in the first area 201a, the distortion of the optical system 201 is small and the resolution is high, so that a higher definition image can be obtained than that in the second area 201b. Therefore, good visibility can be obtained by setting the first area 201a (first angle of view 30) to be a target area of the user 40. For example, as illustrated in FIG. 15A, in a case where the image pickup apparatus 20 is disposed at the rear of the movable apparatus 10, a natural perspective sense can be obtained in a case where the user 40 gazes at a rear vehicle or the like by displaying an image corresponding to the first angle of view 30 on the electronic rearview mirror. On the other hand, the second area 201b (second angle of view 31) corresponds to a wide angle of view including the first angle of view 30. Therefore, for example, when the movable apparatus 10 is running backward, an image corresponding to the second angle of view 31 is displayed on the in-vehicle display to assist the user 40 in driving.

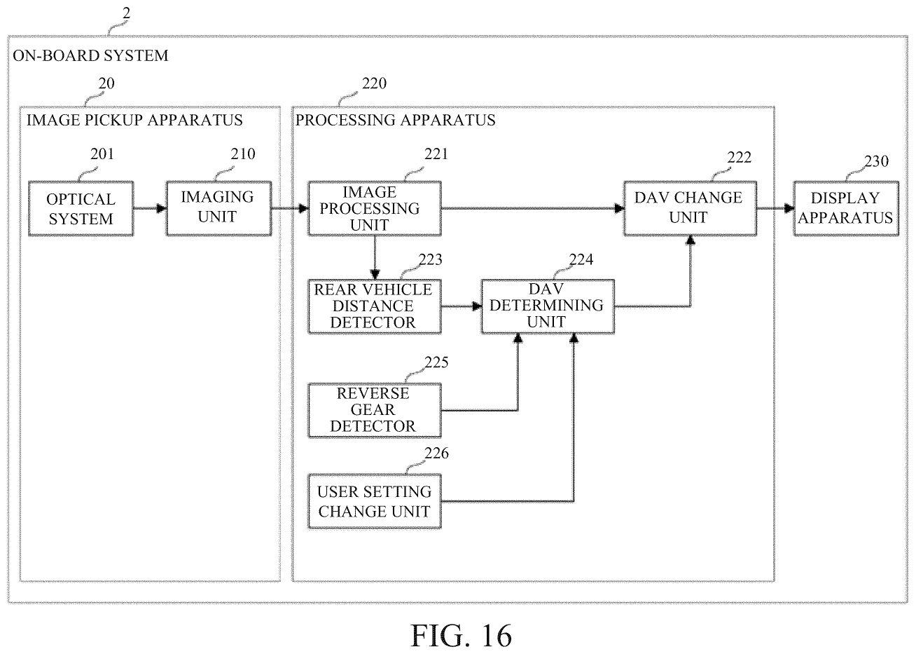

FIG. 16 is a functional block diagram for explaining an example configuration of the on-board system 2 according to this embodiment. The on-board system 2 is a system for displaying to the user 40 an image obtained by the image pickup apparatus 20 installed at the rear of the movable apparatus 10. The on-board system 2 includes the image pickup apparatus 20, a processing apparatus 220, and a display apparatus (display unit) 230. The image pickup apparatus 20 includes the optical system 201 and the imaging unit 210 as described above. The imaging unit 210 includes an image sensor such as a CCD sensor or a CMOS sensor, and generates imaging data by photoelectrically converting an optical image formed by the optical system 201, and outputs the imaging data to the processing apparatus 220.

The processing apparatus 220 includes an image processing unit 221, a display-angle-of-view (DAV) determining unit 224, a user setting change unit 226 (first change unit), a rear vehicle distance detector 223 (first detector), a reverse gear detector 225 (second detector), and a DAV change unit 222 (second change unit). The processing apparatus 220 is a computer such as a Central Processing Unit (CPU) microcomputer, and functions as a control unit that controls the operation of each component based on a computer program. At least one of the components of the processing apparatus 220 may be realized by hardware such as an Application Specific Integrated Circuit (ASIC) or a Programmable Logic Array (PLA).

The image processing unit 221 generates image data by performing image processing such as Wide Dynamic Range (WDR) correction, gamma correction, Look Up Table (LUT) processing, and distortion correction for the image data acquired from the imaging unit 210. The distortion is corrected on at least the image data corresponding to the second area 201b. Thereby, the user 40 is likely to visually recognize an image when it is displayed on the display apparatus 230, and also improves a detection rate of the rear vehicle in the rear vehicle distance detector 223. The distortion correction does not have to be performed on the image data corresponding to the first area 201a. The image processing unit 221 outputs the image data generated by executing the image processing as described above to the DAV change unit 222 and the rear vehicle distance detector 223.

The rear vehicle distance detector 223 acquires information on a distance to a rear vehicle included in the image data corresponding to a range of the second angle of view 31 that does not include the first angle of view 30, using the image data output from the image processing unit 221. For example, the rear vehicle distance detector 223 can detect a rear vehicle based on image data corresponding to the second area 201b among the image data, and calculate a distance to his vehicle from changes in the position and size of the detected rear vehicle. The rear vehicle distance detector 223 outputs information on the calculated distance to the DAV determining unit 224.

The rear vehicle distance detector 223 may further determine a vehicle type of the rear vehicle based on data on characteristic information such as a shape and color for each vehicle type output as a result of machine learning (deep learning) based on an image of a large number of vehicles. At this time, the rear vehicle distance detector 223 may output information on the vehicle type of the rear vehicle to the DAV determining unit 224. The reverse gear detector 225 detects whether the transmission of the movable apparatus 10 (user's vehicle) is in the reverse gear, and outputs the detection result to the DAV determining unit 224.

The DAV determining unit 224 determines whether the angle of view (display angle of view) of the image to be displayed on the display apparatus 230 is to be the first angle of view 30 or the second angle of view 31 based on an output from at least one of the rear vehicle distance detector 223 and the reverse gear detector 225. Then, the DAV determining unit 224 outputs a predetermined result to the DAV change unit 222 according to the determination result. For example, the DAV determining unit 224 can determine that the display angle of view is to be the second angle of view 31 in a case where a distance value in the distance information is equal to or smaller than a certain threshold value (e.g., 3 m), and can determine that the display angle of view is to be the first angle of view 30 in a case where the distance value is larger than the threshold value. Alternatively, the DAV determining unit 224 can determine that the display angle of view is to be the second angle of view 31 in a case where the reverse gear detector 225 notifies the user that the transmission of the movable apparatus 10 is in the reverse gear. The DAV determining unit 224 can determine that the display angle of view is to be the first angle of view 30 in a case where the vehicle is not in the reverse gear.

The DAV determining unit 224 can determine that the display angle of view is to be the second angle of view 31 in a case where the transmission of the movable apparatus 10 is in the reverse gear, regardless of the result of the rear vehicle distance detector 223. The DAV determining unit 224 can determine that the display angle of view is to be determined according to the detection result of the rear vehicle distance detector 223 in a case where the transmission of the movable apparatus 10 is not in the reverse gear. The DAV determining unit 224 may change the determination criterion for changing the angle of view according to the vehicle type of the movable apparatus 10 by receiving vehicle type information from the rear vehicle distance detector 223. For example, in a case where the movable apparatus 10 is a large vehicle such as a truck, its braking distance is longer than that of a standard vehicle, so the above threshold value may be set larger than that of the standard vehicle (for example, 10 m).

The user setting change unit 226 allows the user 40 to change the determination criteria for determining whether or not the display angle of view is changed to the second angle of view 31 by the DAV determining unit 224. The determination criteria set (changed) by the user 40 are input from the user setting change unit 226 to the DAV determining unit 224. The DAV change unit 222 generates a display image to be displayed on the display apparatus 230 according to the determination result by the DAV determining unit 224. For example, in a case where it is determined that the first angle of view 30 is to be used, the DAV change unit 222 cuts out a rectangular sandwiched angle image (first image) from the image data corresponding to the first angle of view 30 and outputs it to the display apparatus 230. In a case where a rear vehicle that satisfies a predetermined condition is present in image data corresponding to the second angle of view 31, the DAV change unit 222 outputs an image (second image) including the rear vehicle to the display apparatus 230. The second image may include an image corresponding to the first area 201a. The DAV change unit 222 functions as a display control unit configured to perform display control for switching between a first display state in which the display apparatus 230 displays a first image and a second display state in which the display apparatus 230 displays a second image.

The DAV change unit 222 cuts out an image by storing the image data output from the image processing unit 221 in a storage unit (memory) such as a RAM, and by reading out the image to be cut out from there. An area in the image data that corresponds to the first image is a rectangular area at the first angle of view 30 that corresponds to the first area 201a. An area in the image data that corresponds to the second image is a rectangular area including the rear vehicle at the second angle of view 31 that corresponds to the second area 201b.

The display apparatus 230 includes a display unit such as a liquid crystal display or an organic EL, and displays a display image output from the DAV change unit 222. For example, the display apparatus 230 includes a first display unit as an electronic rearview mirror disposed above the windshield (front glass) of the movable apparatus 10, and a second display unit as an operation panel (monitor) disposed below the windshield of the movable apparatus 10. This configuration can display the first image and the second image generated from the image data described above on the first display unit and the second display unit, respectively. The first display unit may include a half-mirror so that it may function as a mirror in a case where it is not used as a display unit. The second display unit may serve as a display unit for a navigation system or an audio system, for example.

The movable apparatus 10 is not limited to a vehicle such as an automobile, but may be a movable unit such as a ship, an aircraft, an industrial robot, or a drone. The on-board system 2 according to this embodiment is used to display an image to the user 40, but is not limited to this example. For example, the on-board system 2 may also be used for driving assistance such as cruise control (including an adaptive cruise control function) and automatic driving. The on-board system 2 is not limited to a movable unit and is applicable to various devices that use object recognition, such as an intelligent transport system (ITS).

While the disclosure has described example embodiments, it is to be understood that some embodiments are not limited to the disclosed embodiments. The scope of the following claims is to be accorded the broadest interpretation so as to encompass all such modifications and equivalent structures and functions.

For example, the optical system according to each example is assumed to be used in the visible range and is configured to perform good aberration correction in the entire visible range, but the wavelength range in which the aberration correction is performed may be changed, as necessary. For example, each optical system may be configured to perform aberration correction only in a specific wavelength range in the visible range, or may be configured to perform aberration correction in a wavelength range in the infrared range other than the visible range.

The on-board system 2 may employ the distance measuring apparatus described as the image pickup apparatus 20. At this case, the on-board system 2 may include a determining unit configured to determine a collision likelihood with an object based on information on a distance to the object acquired by the image pickup apparatus 20. A stereoscopic camera having two imaging units 210 may be adopted as the image pickup apparatus 20. In this case, even if an imaging-surface phase-difference sensor is not used, image data can be simultaneously acquired by each of the synchronized imaging units, and the two image data can be used to perform the same processing as described above. As long as a difference in imaging time between respective imaging units is known, each imaging unit does not need to be synchronized.

Each example can provide an optical system that has a reduced size and a wide angle of view.

This application claims priority to Japanese Patent Application No. 2023-204465, which was filed on Dec. 4, 2023, and which is hereby incorporated by reference herein in its entirety.

What is claimed is:

1. An optical system comprising, in order from an object side to an image side:
a front group; and
a rear group,
wherein the front group includes, in order from the object side to the image side, a first lens having negative refractive power and a second lens having an aspheric surface,
wherein the rear group includes, in order from the object side to the image side, a third lens having positive refractive power, a fourth lens having positive refractive power, a fifth lens having negative refractive power, and a sixth lens having an aspheric surface, and
wherein on an optical axis, an object-side surface of the first lens is convex, an object-side surface of the second lens is convex, and an object-side surface of the sixth lens is concave.

2. The optical system according to claim 1, wherein the following inequality is satisfied:
$$1. < f 3 / f < 1.8$$
where f is a focal length of the optical system, and f3 is a focal length of the third lens.

3. The optical system according to claim 1, wherein the following inequality is satisfied:
$$1. < f \times sin ( θ max ) / y ( θ max ) \leq 1.9$$
where θ [deg.] is a half angle of view of the optical system, y(θ) is a projection characteristic expressing a relationship between the half angle of view θ and an image height y, and θ max is a maximum half angle of view of the optical system.

4. The optical system according to claim 1, wherein the following inequality is satisfied:
$$0.65 < y ( θ max / 2 ) / y ( θ max ) < 0.85$$
where θ [deg.] is a half angle of view of the optical system, y(θ) is a projection characteristic expressing a relationship between the half angle of view θ and an image height y, and θ max is a maximum half angle of view of the optical system.

5. The optical system according to claim 1, wherein the object-side surface of the second lens is an aspheric surface having an inflection point in a section having the optical axis.

6. The optical system according to claim 1, wherein the following inequality is satisfied:
$$0.8 < t 23 / fR < 1.5$$
where t23 is a distance on an optical axis from an image-side surface of the second lens to an object-side surface of the third lens, and fR is a focal length of the rear group.

7. The optical system according to claim 1, wherein the following inequality is satisfied:
$$1.2 < f 3 / f 4 < 1.7$$
where f4 a focal length of the fourth lens.

8. The optical system according to claim 1, wherein the following inequality is satisfied:
30<ν3<100
where ν3 is an Abbe number based on d-line of the third lens.

9. The optical system according to claim 1, wherein the object-side surface of the sixth lens is aspheric and has no extreme value in a radial direction in a section having the optical axis.

10. The optical system according to claim 1, wherein a tilt of the object-side surface of the sixth lens relative to a plane perpendicular to the optical axis increases monotonically in a radial direction in a section having the optical axis.

11. The optical system according to claim 1, wherein an image-side surface of the sixth lens is aspheric and has no extreme value in a radial direction in a section having the optical axis.

12. The optical system according to claim 1, wherein a tilt of an image-side surface of the sixth lens relative to a plane perpendicular to the optical axis increases monotonically in a radial direction in a section having the optical axis.

13. The optical system according to claim 1, wherein the following inequality is satisfied:
$$- 0.3 < ( R 32 + R 31 ) / ( R 32 - R 31 ) < 0.15$$
where R31 is a radius of curvature of an object-side surface of the third lens, and R32 is a radius of curvature of an image-side surface of the third lens.

14. The optical system according to claim 1, wherein the following inequality is satisfied:
$$- 6. < f 1 / f < - 3.$$
where f1 is a focal length of the first lens.

15. The optical system according to claim 1, wherein the rear group includes an aperture stop.

16. The optical system according to claim 1, wherein the front group has negative refractive power, and the rear group has positive refractive power.

17. The optical system according to claim 1, wherein a fourth lens and a fifth lens are cemented together to form a cemented lens.

18. An image pickup apparatus comprising:
the optical system according to claim 1; and
an image sensor configured to capture an object via the optical system.

19. A system comprises:
the image pickup apparatus according to claim 18; and
a display apparatus configured to display an image obtained based on an output of the image pickup apparatus.

20. A movable apparatus comprising:
the image pickup apparatus according to claim 18,
wherein the movable apparatus is configured to hold and move the image pickup apparatus.
